(19) United States
(12) Patent Application Publication
(10) Pub. No.: US 2004/0032100 A1
(43) Pub. Date: Feb. 19, 2004

(54) Method and apparatus for improved cart attachment mechanism

(75) Inventor: Darren Clay Forshee, Denton, TX (US)

Correspondence Address: Darren Clay Forshee, 2912 Longfellow, Denton, TX, 76209, US

(73) Assignee: Darren Clay Forshee

(21) Appl. No.: 10/352,390

(22) Filed: Jan. 27, 2003

Related U.S. Application Data
(63) Continuation-in-part of application No. 10/152,968, filed on May 21, 2002.

(51) Int. Cl. B62D 39/00

(52) U.S. Cl. 280/33.991

(57) ABSTRACT

An improved attachment mechanism for attaching an article conveyance device to a personal mobility device. The article conveyance device is attached to the personal mobility device via attachable arms that extend from a beam. One end of the attachable arms is mounted along the beam. In a preferred embodiment, a plate is affixed to each end of the beam. The plate is mounted to the article conveyance device in a manner that allows the plate to rotate, or pivot, around the point at which it is mounted to the conveyance device. Thus, the beam is allowed to move in an arc, relatively vertically, in order to accommodate varying heights of and connection points to personal mobility devices. The attachable arms of the disclosed attachment mechanism are designed to connect to the frame of a personal mobility device. Preferably, the frame of the personal mobility device is secured to the mechanism via clips in the ends of the attachable arms. The clips allow the frame of the personal mobility device to be securely inserted but provide enough resistive force to prevent, in normal operation, the attachment mechanism from detaching from the personal mobility device without pro-active force being applied by the operator.

### CROSS-REFERENCE TO RELATED APPLICATION

This application claims priority and is a continuation-in-part of U.S. patent application Ser. No. 10/152,968 filed May 21, 2002 and entitled Wheelchair Attachable Shopping Cart, which is hereby incorporated by reference.

### FIELD OF THE INVENTION

The present invention relates to attachment mechanisms and, more particularly, to mechanisms that enable carts or other article conveyance devices to be adapted for use by disabled persons with a personal mobility device, for example, a wheelchair.

### BACKGROUND OF THE INVENTION

Approximately three and a half million people in the United States are disabled and confined to wheelchairs, depending on them for their primary mobility. Such persons must still carry on with ordinary tasks such as shopping at stores for groceries, clothes, and other items. The carts and other devices for holding articles selected by customers provided by most stores are designed for the majority of customers. That is, the devices are built for those that can walk and push a cart, not for those that are personal mobility device bound.

Most wheelchairs or other personal mobility devices are not designed or equipped with a cart or basket or other article conveyance device that would allow articles selected from the shelves of such stores to be carried along while shopping and finally to a checkout counter or area. Those personal mobility devices that do include a device for holding the selected articles, e.g., a cart or basket, often have such a small holding area that no more than a few articles can be selected and carried before it becomes necessary to “check out”. Moreover, very few options presently exist that allow the disabled to take advantage of the devices usually provisioned by stores for carrying items selected for purchase, e.g., shopping carts.

U.S. Pat. No. 5,813,582, entitled Adjustable Shopping Basket for Wheelchairs, is an example of one such attempt to accommodate a wheelchair bound customer with a carrying ability. The patent describes a basket designed to attach to the armrests of a wheelchair. However, the basket is not of a holding capacity generally offered to consumers shopping in grocery stores. Even with its reduced capacity, the loading of items into the basket is likely to cause a balance problem as the wheelchair and the armrests in particular are front loaded with more weight than their design specification recommends. Moreover, ingress and egress with respect to the wheelchair is limited once such a basket is attached.

Background: Motorized Cart Options

Motorized personal mobility devices, such as the Hoveround™, and other powered wheelchairs are widely available. However, compared to the cost of a manually operated wheelchair, such powered devices are quite expensive. Thus, a small percentage of the personal mobility device bound use such powered devices. Moreover, learning to control and maneuver such devices is difficult as there is no control standard from one powered device to another that can be relied upon.

Although some powered devices include a basket or cart, as stated above, such holding devices are usually too small to accommodate a shopping trip of any great length of time. As a result, few stores provide powered devices to assist their personal mobility device bound customers during shopping. A related problem with those powered devices provisioned by stores is that the mobility device bound customer must be able to move from his or her own personal mobility device to the device provided by the store. While some persons needing such devices have an amount of limited mobility that would allow them to make such moves, not all do.

Background: Non-Powered Mobility Devices

Most non-powered personal mobility devices are designed and built as general or multi-purpose devices. Therefore, they do not include a basket or other holding device of any kind. Moreover, there is likely not an attachment option or mechanism designed into the device that would allow for such a holding device to be attached to the personal mobility device. There is also generally not an element designed into the personal mobility device specifically to accommodate an article conveyance device, such as a larger cart or other holding device. Consequently, several systems have been developed in an attempt to accommodate a personal mobility device bound person with a shopping and article conveyance ability.

U.S. Pat. No. 6,186,528, entitled Wheelchair and Trailer System, is an example of one such attempt to accommodate with carrying ability. The patent describes a trailer designed to attach to the back of a wheelchair. While allowing for an increase in holding and carrying capacity, the system described has distinct disadvantages. Most notably, because the trailer described follows behind the wheelchair to which it is attached, the operator of the chair is not given an ease of use. For example, in a situation where the wheelchair operator is shopping in a store, the operator must be able to turn approximately one hundred and eighty degrees around in order to be able to place the selected items into the trailer. It is quite possible that many operators will not have the ability to maneuver effectively enough to use such a trailer. Moreover, the operator must be able to reach the trailer behind the wheelchair in order to place selected items onto it.

Another example of an attempt to accommodate with carrying ability is disclosed in U.S. Pat. No. 5,769,440, entitled Wheelchair With Mobile Accessory. This patent describes a mobile cart designed to be attached to a wheelchair via at least one hitch comprising a j-bar and clamps. The described device is attached to a wheelchair using c-clamps that are permanently mounted to the wheel chair or, in any case, are affixed to the wheelchair frame so as to not be easily removable. The j-bar is held within the c-clamps by the tightening of at least two bolt and nut combinations. This disclosed assembly can suffer from the same problems as the trailer system described above. Moreover, the forces applied via the draw bar during cornering and other turning maneuvers tend to put stress on both the wheelchair and the shopping cart. In particular, the stress placed on the wheelchair could cause its frame to twist in a way that it was not designed, thus damaging the wheelchair for normal use. Additionally, the permanent, or at the very least, time consuming, modifications required to the wheelchair in order to tow the cart and the time and dexterity required to hitch and de-hitch the cart are not conducive to its use in a consumer shopping environment.

Another example of an attempt to accommodate with carrying ability is disclosed in U.S. Pat. No. 4,350,601, entitled Shopping Cart for the Handicapped. This patent describes a shopping cart designed to be attached to a wheelchair via a releasable latch and hitch assembly. The described device is attached to one side of the wheelchair with a socket connected to a draw arm that has been fixed to one side of a shopping cart on the other end. This assembly, which attaches on a side of a wheelchair and a side of a shopping cart, appears inherently unstable as all stresses are put on one place at the cart and at the wheelchair. Thus it can suffer from the same problems are the trailer assemblies described above.

Another example of an attempt to accommodate with carrying ability is disclosed in U.S. Pat. No. 4,484,755, entitled Wheeled Cart for Use by Handicapped, Invalid and Frail Persons. This patent presents a shopping cart that has been modified to attach to the frame of a wheelchair in multiple places. However, the description of the basket design and its means for attaching to a wheelchair make the design unusable for those mobility device bound persons that wish to exit and enter their mobility devices without disconnecting and connecting the basket each time. Moreover, the cart is depicted as attaching to the arms of a wheelchair. Such an attachment position and means for attachment creates a potential for damage to the wheelchair in a much more visible position than if the attachment were made in a more convenient place for entry and exit of the wheelchair. Moreover, in an emergency, quick exit from the wheelchair would be impossible.

Thus, there is a need for an article conveyance device and attachment mechanism that can enable a personal mobility device to effectively utilize an article conveyance device. There is also a need for an article conveyance device and attachment mechanism to provide a stable attachment that can be easily maneuvered by the personal mobility device operator. There is also a need for an article conveyance device and attachment mechanism to attach and detach easily enough that the majority of those needing its use would be able to operate it. There is also a need for an article conveyance device and attachment mechanism to allow for ease of ingress and egress with regard to the personal mobility device. There is also a need for an attachment mechanism to reasonably prevent damage to the personal mobility device. Preferably, such an attachment mechanism should work with existing or standard article conveyance device designs. Preferably, the article conveyance device should be designed with a holding capacity similar to those offered customers that are not personal mobility device bound. Preferably, the conveyance device and mechanism should be able to attach to most existing and standard personal mobility device designs.

### SUMMARY OF THE INVENTION

The present application discloses an improved attachment mechanism for attaching an article conveyance device to a personal mobility device. In the presently preferred embodiment, the attachment mechanism is designed to attach to the lower part of the frame of a personal mobility device. The article conveyance device is attached to the personal mobility device via attachable arms that extend from a relatively rigid square beam. One end of the attachable arms is slidably mounted along the beam to enable accommodation of varying widths of personal mobility devices. The square beam is of a length that enables it to mount to the frame or other relatively rigid portion of the article conveyance device.

In a preferred embodiment, a plate is affixed to each end of the beam. The plate is mounted to the article conveyance device in a manner that allows the plate to rotate, or pivot, around the point at which it is mounted to the conveyance device. Thus, the square beam is allowed to move in an arc, relatively vertically, in order to accommodate varying heights of and connection points to personal mobility devices. The attachable arms of the disclosed attachment mechanism are designed to connect to the frame of the personal mobility device. The ends of the attachable arms that attach to the frame are preferably cup (or U) shaped such that the frame of the personal mobility device is surrounded on three sides by the end of the attachable arm. The open end allows for a portion of the frame of the personal mobility device to be inserted into the arm end.

Preferably, the frame of the personal mobility device is secured to the mechanism via clips in the ends of the attachable arms. The clips allow the frame of the personal mobility device to be securely inserted but provide enough resistive force to prevent, in normal operation, the attachment mechanism from detaching from the personal mobility device without pro-active force being applied by the operator. The attachable arm ends could also be secured using straps, buckles, hook and loop, or any other manner of securing two items. The attachable arm ends could also be formed of a slightly flexible material that would allow the mobility device frame to slip into the end but provide enough grip to prevent, in normal operation, the attachment mechanism from detaching from the personal mobility device without pro-active force being applied by the operator.

In an alternate embodiment, the attachable arms are attached directly to the article conveyance device frame via affixed plates and without a beam. The attachable arms are mounted to the article conveyance device in the same manner as the beam such that they can rotate, or pivot, in an arc, relatively vertically, and have the same variety of attachment ends for connecting to the frame of the personal mobility device. The arms can be hinged to allow horizontal flexibility and accommodation of a variety of widths of personal mobility devices.

In an alternate embodiment, the attachable arms are mounted along the beam and connected together at a central point on the beam. The connection at the central point is accomplished with connectors, such as pins or hinges, that allow the attachable arms to pivot horizontally to accommodate varying widths of personal mobility devices. Preferably, the attachment ends of the arms have the portion designed to receive the frame of the personal mobility device disposed on the inside, relative to the horizontal movement of the arms. The ends of the attachable arms have the same variety of connectors for connecting to the frame of the personal mobility device.

One or more of the disclosed embodiments provides one or more of the following advantages:

An easily usable attachment mechanism to facilitate use of an article conveyance device;

a reduced number of attachment mechanism components over the prior art;

a stable connection between article conveyance device and personal mobility device;

an attachment mechanism and article conveyance device that can be easily maneuvered;

an attachment mechanism that can be attached and detached easily;

an attachment mechanism that provides ease of ingress and egress while the article conveyance device is attached;

an attachment mechanism that reduces the potential for damage to the personal mobility device;

an attachment mechanism that can accommodate varying designs of personal mobility devices;

an attachment mechanism that can accommodate varying designs of article conveyance devices;

an attachment mechanism and article conveyance device with holding capacity more closely resembling the holding capacity provided by stores to the majority of their shoppers.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 depicts an exploded top view of the components that constitute the disclosed improved attachment mechanism;

FIG. 2 is an isometric view of the attachment apparatus of the parent application;

FIGS. 3a and 3b depict side views of an arm and an end plate of the disclosed improved attachment mechanism, respectively;

FIG. 4 depicts an isometric view of a rotatable mounting for an end plate of the disclosed improved attachment mechanism;

FIG. 5 depicts a top view of a rotatable mounting for an end plate of the disclosed improved attachment mechanism attached to an article conveyance device;

FIGS. 6a-6c depict top, side, and rear views, respectively of the disclosed improved article conveyance device with the improved attachment mechanism;

FIG. 7 depicts an attachable arm of an alternate embodiment of the disclosed improved article conveyance device and attachment mechanism;

FIG. 8 depicts a rear view of an alternate embodiment of the disclosed improved article conveyance device and attachment mechanism; and

### DETAILED DESCRIPTION OF THE PREFERRED EMBODIMENTS

The numerous innovative teachings of the present application will be described with particular reference to the presently preferred embodiment. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others. Various embodiments of the disclosed mechanism and device will be described using a typical shopping cart as an example only. The typical shopping cart of the example has measurements of: a front height of approximately 31.625 inches from floor to basket top; a rear height of approximately 33.5 inches from floor to handle top; a front width of approximately 18 inches from basket side to basket side; a rear width height of approximately 19.5 inches from basket side to basket side; a rear wheeled base width of approximately 26 inches from rear wheel inside to rear wheel inside; and a frame cross bar for attaching the disclosed attachment mechanism width of approximately 24.375 inches.

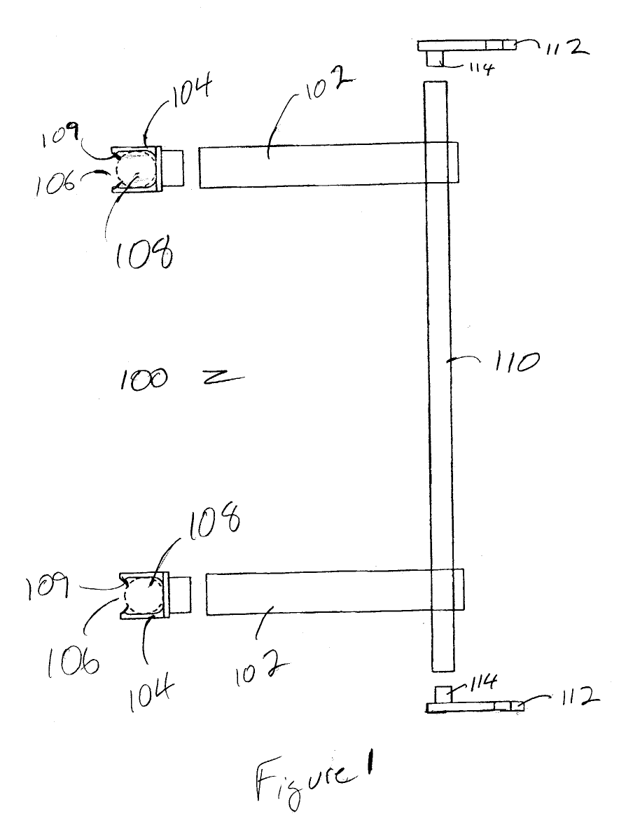

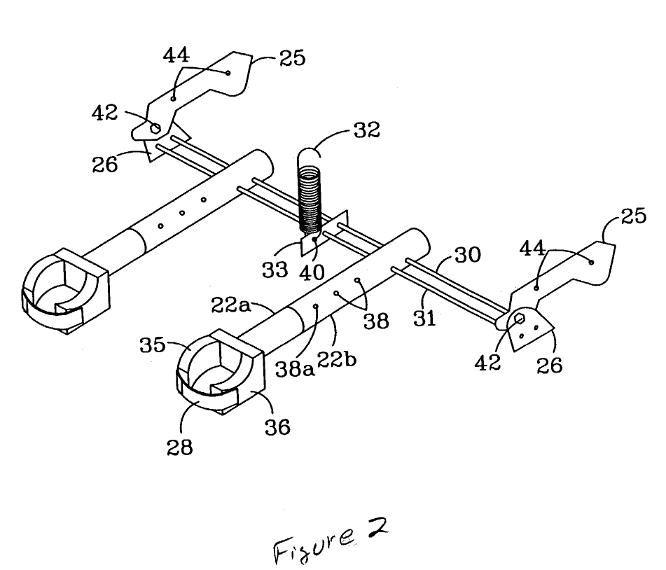

Before describing the improvements of the present disclosure, a short discussion of the parent application, entitled Wheelchair Attachable Shopping Cart will follow. FIG. 2 is an isometric view of the attachment apparatus of the parent application. Brackets 25 are secured to the shopping cart by bolts (not shown) that are inserted through openings 44. Plates 26 are attached to brackets 25 by bolts, rivets, or welding. Rods 30 and 31 are attached to and extend between plates 26. Attachment arms 22 are slidaby mounted on rods 30 and 31 so that they may be moved independently of each other in a horizontal direction. This allows attachment arms 22 to be adjusted to connect to frame supports on a wheelchair. Attachment arms 22 will also move up and down vertically since rods 30 and 31 are flexible. Attachment arms 22 are held in an upward position, when not attached to the frame supports of a wheelchair, by spring 32. Spring 32 is attached at one end to rods 30 and 31 and to the shopping cart basket under which the attachment apparatus is mounted (illustrated in FIG. 1 of the parent application). Attachment arms 22 may be adjusted as to length utilizing the slidably mounted two parts 22a and 22b, and the spring loaded locking pin 38a and openings 38. Utilizing the adjustable lengths of the attachment arms 22, the distance from the shopping cart to the wheel chair may be adjusted to accommodate both short and tall persons. Since the attachment arms are attached to a support frame of a foot rest of a wheelchair, a person may enter and leave the wheelchair without detaching the shopping cart.

FIG. 1 depicts an exploded top view of the components that constitute the disclosed improved attachment mechanism. In the presently preferred embodiment, an attachment mechanism 100 attaches an article conveyance device, for example, the typical shopping cart example described above, to a personal mobility device, for example, a wheelchair.

The attachment mechanism 100 is connected to the personal mobility device using attachable arms 102. In the presently preferred embodiment, two such attachable arms 102, fabricated out of a relatively rigid substance, for example, steel, another metal, or any other substance that can be fashioned and is capable of withstanding the stress, strain, torque, and sheer forces that will be applied during normal use, can be utilized. Each attachable arm 102 is equipped with an end 104 that is cup, or U, shaped. That is, the end 104 has an opening 106 allowing entry of an object 108 into the end 104.

In the presently preferred embodiment, the opening 106 of the end 104 facilitates receiving part of the frame of a personal mobility device 108. An end 104 can be of a single piece with an arm 102. Alternatively, an end 104 could be a separate piece connected to an arm 102. Connection of end 104 to arm 102 as a separate piece can be accomplished by welding or other forms of permanent, rigid affixation. End 104 can also be connected to arm 102 using a rotatable connector, for example, a screw type connector. Use of a screw-type connector, or other connector that allows for free rotation of the end 104, would allow the opening 106 of an end 104 to receive a part of a personal mobility device frame 108 at varying angles. In the typical shopping cart example, the arms 102 would be approximately 12 inches in length but could be adjusted depending on the characteristics of the article conveyance device. Thus, the attachment mechanism 100 can be made to accommodate varying designs of existing and future personal mobility device frames.

The end 104 of the presently preferred embodiment is designed with a clip 109. The clip 109 is designed to receive the frame 108 and secure it to the attachment mechanism 100. The clip portion 109 of the end 104 can be of the same or different material as the end 104 or of a more flexible material such as rubber or plastic. The clip 109 allows the attachment mechanism 100 and a personal mobility device to act in concert on an article conveyance device. In addition to, or instead of, the clip 109, the end 104 can secure the personal mobility device using straps, buckles, hook and loop, or any other manner of securing two items. The ends 104 could also secure the personal mobility device through use of a slightly flexible material that would allow the personal mobility device frame to slip into the end 104 but resist allowing the frame to become accidentally detached. Preferably, the clip 109, or any other securing mechanism incorporated on the end 104, provides enough resistive force to prevent, in normal operation, the attachment mechanism from detaching from the personal mobility device without pro-active force being applied by the operator

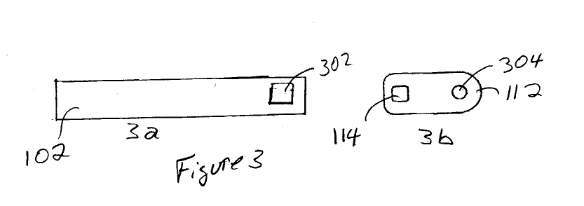

The arms 102 are preferably but not necessarily square and are slidably mounted to the remainder of the attachment mechanism 100 on an end opposite the cup shaped end 104. In the presently preferred embodiment, the arms 102 are mounted along a relatively rigid hollow square beam 110. In the typical shopping cart example, the beam 110 is approximately one (1) inch square in width and height, having a length approximately equal to the length of the frame cross bar of the shopping cart. The beam 110 is fabricated out of the same or similar substance as the attachment arms 102. FIG. 3a depicts a side view of an arm 102 of the disclosed improved attachment mechanism 100. An opening 302 in arm 102 slightly greater but proportional to the outside dimensions of the beam 110 allows the arm 102 to be securely mounted to the beam 110. That is, the dimensions of the opening 304 should accommodate the beam 110 but minimize any vertical movement independent of the attachment mechanism 100 and aid in the horizontal movement of the arms 102 by maintaining the arm 102 in a position that is relatively perpendicular to the beam 110.

In the presently preferred embodiment, the arm 102 with a square opening 302 mounted on the beam 110 allows the arms 102 freedom to be moved along the beam 110, for example, horizontally, while limiting the movement of the arms 102 vertically. When the beam 110 is rotated along an arc relatively perpendicular to the arms 102, the arms 102 will raise, or lower. Thus, the attachment mechanism 100 can be made to accommodate varying frame widths of existing and future personal mobility devices. Moreover, the need for an attachment mechanism having multiple rods as in the parent application is eliminated.

At each end of the beam 110, a single end plate 112 is affixed. In the presently preferred embodiment, the end plate 112 is fabricated out of the same or similar substance as the attachment arms 102 and beam 110. The height of the end plate 112 is preferably approximately that of the beam 110 with the end plate 112 width, for the typical shopping cart example, being approximately 0.25 inches. In the presently preferred embodiment, the end plate is designed with a protrusion 114 approximately matching the inner dimension of the end of the beam 110 and in the typical shopping cart example, approximately 0.75 inches long. The male protrusion 114 is mated to the female hollow at the end of the beam 110. Thus, little or no movement of the beam 110 relative to the end plate 112 is allowed as the beam is rotated, or pivoted, or, as a corollary, as the end plates are rotated, or pivoted. That is, the movement of one causes a corresponding movement of the other.

The end plate 112 can be attached to the beam 110 by any of various ways. For example, the end plate 112 can be attached to the beam 110 by way of friction, if the tolerances of the protrusion 114 and the end of the beam are tight, e.g., close, enough. The end plate can also be permanently attached to the beam 110, for example, by welding. As will be evident from later portions of the detailed description, the end plates 112 may also be connected to the beam 110 through the pressure exerted as a result of the attachment mechanism being attached to the personal mobility device. The attachment of the end plate 112 and the beam 110 should allow for little or no movement of one relative to the other. That is, the end plate 112 and beam 110 should move as a unit. Thus the need for two end plates at each end of the two rods, as in the parent application, is eliminated.

In the presently preferred embodiment, the end plate extends outwardly away from the beam 110 in a direction opposite the arms 102. In the typical shopping cart example, the length of the end plate 112 is approximately 3.5 inches. FIG. 3b depicts a side view of an end plate 112 of the disclosed improved attachment mechanism 100. This figure discloses an opening 304 at an end of the end plate 112 opposite the protrusion 114. The opening 304 facilitates mounting the end plate 112 to an article conveyance device. In the typical shopping cart example, the opening 304 of the end plate 112 is approximately 0.39 inches in diameter. The mounting of the end plate 112 in a single place on the article conveyance device allows the entire attachment mechanism 100 to rotate, or pivot, and thereby accommodate varying heights of personal mobility devices.

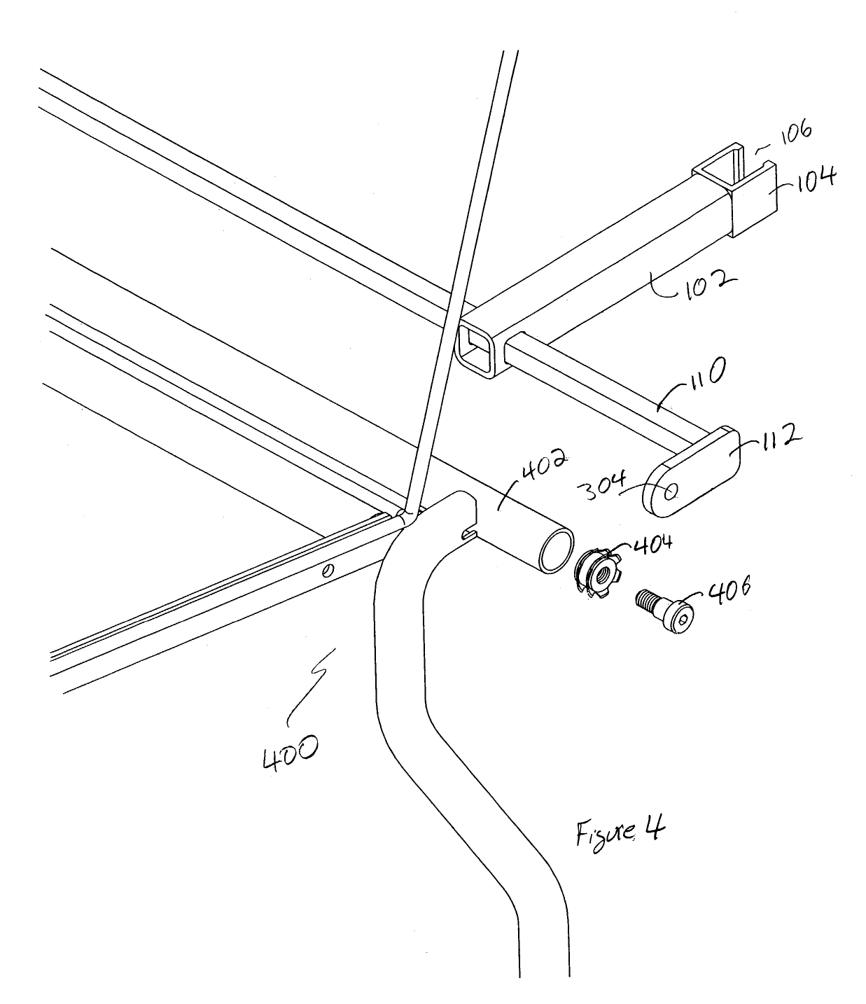

FIG. 4 depicts an isometric view of a rotatable mounting for an end plate 112 of the disclosed improved attachment mechanism 100. An article conveyance device 400 is presented that provides a frame having a hollow horizontal cross bar 402. In the present example, a shopping cart 400 is presented. The cart 400 has a frame with a horizontal cross bar 402 comprised of tubular steel or another suitable replacement, which could include plastic or another lightweight but strong material. In the presently preferred embodiment, a threaded insert 404 that approximates the cross-sectional inner dimension of the cross bar is inserted into the cross bar. In the typical shopping cart example, the insert is a five-sixteenths dash eighteen (5/16-18) type insert. The insert 404 should fit snuggly inside and limit or eliminate any movement of the insert relative to the cross bar 402.

The insert is designed to accommodate a machine or other type of screw 406, for example, a socket shoulder screw. In the typical shopping cart example, the screw 406 is a socket shoulder screw with an approximately 0.375 inch diameter, an approximately 0.313 inch shoulder, and a thread type of five-sixteenths dash eighteen (5/16-18). The screw 406 is inserted through the end plate opening 304 and into the insert 404 and tightened to secure the attachment mechanism to the article conveyance device 400 but allow the attachment mechanism 1100 to rotate, or pivot, around an axis parallel to and coaxial with the cross bar 402 and the screw 406.

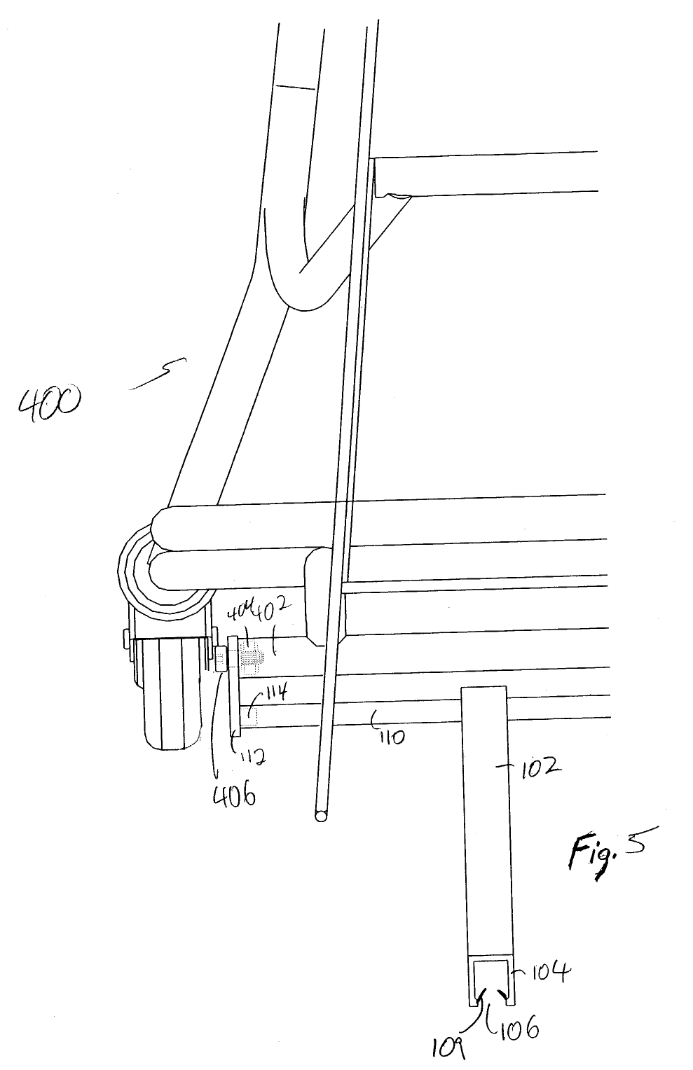

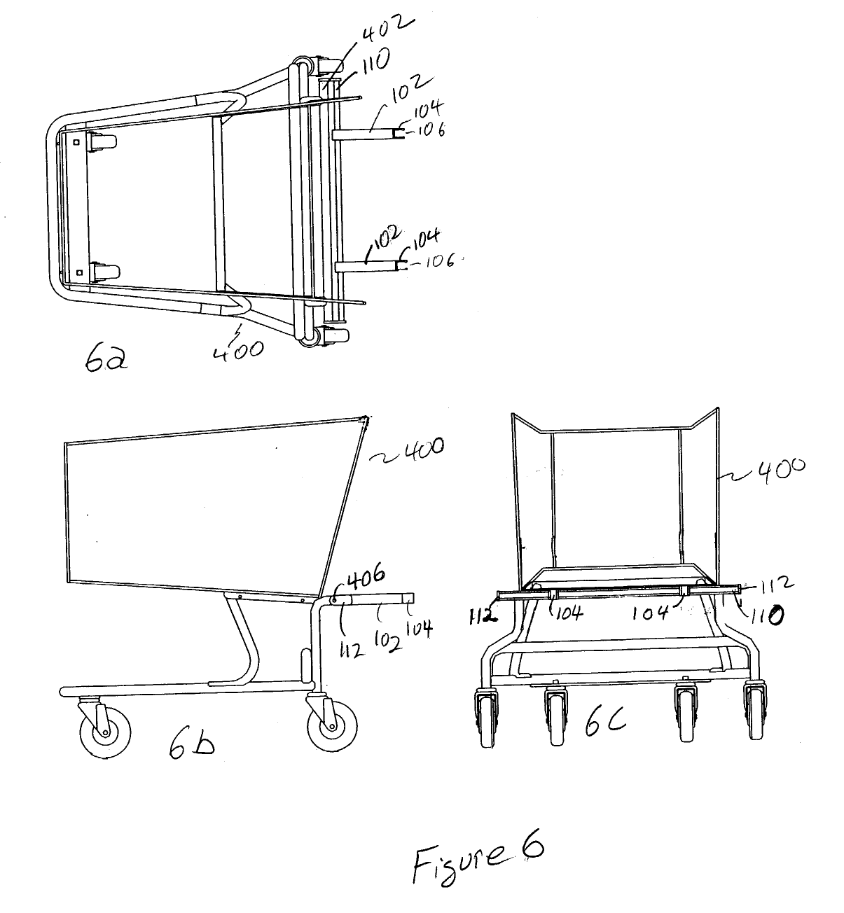

FIG. 5 depicts a top view of a rotatable mounting for an end plate 112 of the disclosed improved attachment mechanism 100 attached to a article conveyance device 400. FIGS. 6a-6c depict top, side, and rear views, respectively of the disclosed improved article conveyance device 400 with the improved attachment mechanism 100.

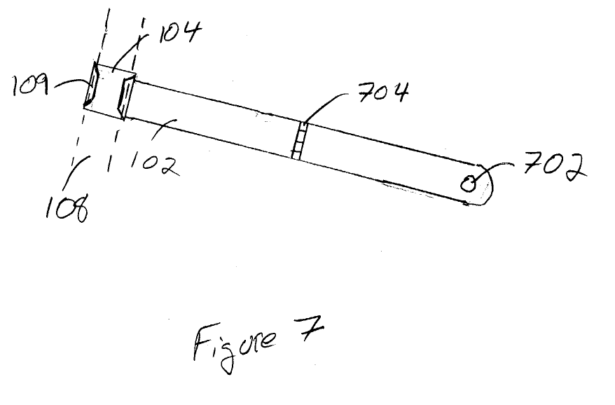

FIG. 7 depicts an alternate embodiment of an attachable arm 102 and the disclosed improved attachment mechanism 100. This alternate embodiment allows the attachment of a article conveyance device without the use of beam 110 or end plate 112. The arms 102 have ends 104 of the same type and character as the ends 104 disclosed above. However, in this alternate embodiment, the ends 104 preferably face inwardly, relative to the article conveyance device and personal mobility device. Also, the arms 102 are connected directly to the article conveyance device 400. Thus, the arms 102 do not slidably mount on the beam 110. Rather, the arms 102 terminate with an opening 702 similar to the opening 304 of the end plate 112.

The connection of the arm 102 to the cross bar 402 is made in the same or similar way as the connection of the end plate 112 to the cross bar 402 in the presently preferred embodiment described above. This connection allows each arm 102 to move vertically independently of the other. This alternate embodiment can be used, for example, with a combination of article conveyance devices and personal mobility devices that require varying heights of connections due to frame constructions or other considerations. Moreover, this embodiment reduces the number of components required to construct the attachment mechanism. The structure of this embodiment also allows for a flatter design of the arm 102, more closely resembling the width of the end plate 112 of the preferred embodiment.

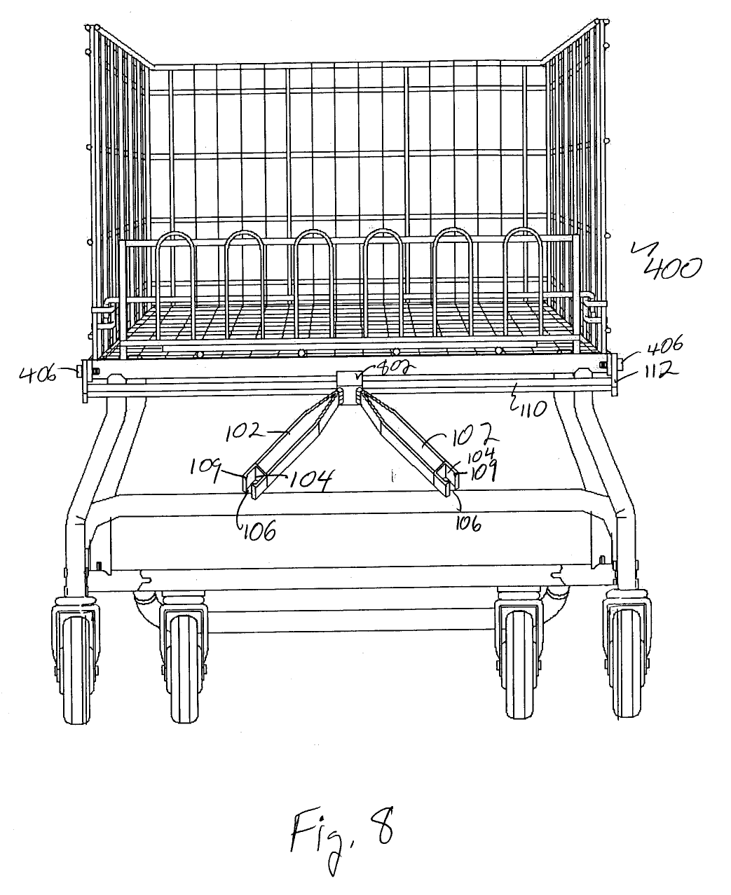

Accommodation of varying widths of personal mobility devices can be provided by a hinge 704 that is disposed along the arm 102 due to the flatter structure of the arm 102. Preferably, the hinge 704 is disposed near the middle of the length of the arm 102. Also, preferably the hinge design should allow the hinge 704 to be locked into place once the arm 102 has accommodated the proper personal mobility device width in order to allow for ease of control and responsiveness with regard to the article conveyance device FIG. 8 depicts a rear view of another alternate embodiment of the disclosed improved article conveyance device with the improved attachment mechanism 100. This alternate embodiment retains the structure of the beam 110 and the end plate 112 of the preferred embodiment. The attachable arms 102 are both connected at a central connecting point 802. Preferably, the connecting point 802 is mounted to the beam 110. The connection of the arms 102 at connecting point 902 can be accomplished by, for example, the arms 102 terminating at the connecting point 902 with openings to accommodate a pin, hinge, or other connection that would enable the arms 102 to move pivot to accommodate varying widths of personal mobility devices.

The arms 102 in this alternate embodiment have ends 104 of the same type and character as the ends disclosed above. In FIG. 8, the ends 104 are depicted as facing away from the beam 110. However, in this alternate embodiment, the ends 104 could also face inwardly, for example, like the ends 104 depcited in FIG. 7, relative to the article conveyance device and personal mobility device.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

For example, the dimensions used in the shopping cart example are not the only dimensions possible. Varying sizes and designs of article conveyance devices and personal mobility devices may call for an increase or decrease in the size of one or more of the components of the attachment mechanism 100, without departing from the scope of this disclosure. Moreover, the stress, mass, or other intended use of the attachment mechanism 100, the article conveyance device, or personal mobility device may dictate that lighter, heavier, stronger, or weaker materials may be used, depending on application, without departing from the scope of this disclosure.

For another example, the end 104 of the arms 102 are described variously as preferably facing outward with respect to the arms or preferably facing inward with respect to the personal mobility device. However, the orientation of the ends 104 of the arms 102 can vary depending on the connection point desired, the stress direction, or any number of factors without departing from the scope of this disclosure.

For another example, as is described in the parent application, the length of the arms 102 can be varied. Any number of ways to adjust the length of the arm 102 can be employed, such as, using telescoping arms, a series of locking openings with a cotter-pin type insert, or any method or design that enables adjustment to the length of the arm 102, without departing from the scope of this disclosure. Adjustment of the length of the arms 102 can allow accommodation of varying sizes and designs of article conveyance devices or personal mobility devices.

For another example, the arms 102 are described as preferably slidably mounted along the beam 110 of the attachment mechanism 100. However, the arms 102 could be permanently affixed to the beam or the beam 110 and arms 102 could be of a unitary construction without departing from the scope of this disclosure. Although such variation would limit the ability of the attachment mechanism 100 to adapt to varying widths of personal mobility devices, the number of components is still reduced over prior art.

For another example, the connecting point 802 could be slidably mounted along the beam 110 in order to accommodate differing or future designs of personal mobility devices. The slidable mount of the connecting point 802 could also enable accommodation of varying designs of article conveyance devices.

For another example, the connection of the attachable arms 102 to the connecting point 802 could be accomplished by spring-loaded, or other tension type, devices.

For another example, the connecting point 802 could be mounted behind the beam 110, relative to the personal mobility device. Some alteration to the attachable arms 102 would be required.

What is claimed is:

1. An article conveyance device attachment apparatus, comprising:
a beam;
a pair of arms, mounted along said beam; and
a pair of end plates attached to said beam;
wherein the end of each of said arms opposite the beam is designed to receive a portion of a personal conveyance device; and
wherein said end plates are designed to attach to an article conveyance device.

2. The apparatus of claim 1, wherein said beam is square, relative to width and height.

3. The apparatus of claim 1, wherein the length of said beam is approximately the width of said article conveyance device.

4. The apparatus of claim 1, wherein said arms are designed to attach to the footrest frame portion of said personal mobility device.

5. The apparatus of claim 1, wherein said arms are slidably mounted along said beam.

6. The apparatus of claim 1, wherein an opening in each of said arms is approximately the same shape and dimensions as said beam, relative to width and height.

7. The apparatus of claim 1, wherein said end of each of said arms opposite said beam is cup shaped.

8. The apparatus of claim 1, wherein said end of each of said arms opposite said beam is connected to said arm.

9. The apparatus of claim 1, wherein said end of each of said arms opposite said beam is rotatably connected to said arm.

10. The apparatus of claim 1, wherein said end of each of said arms opposite said beam is a clip designed to retain a portion of a personal mobility device.

11. The apparatus of claim 1, wherein each said end plate is permanently attached to an end of said beam.

12. The apparatus of claim 1, wherein said beam is hollow and wherein said end plate attachment to said beam is accomplished using a protrusion on said end plate.

13. The apparatus of claim 1, wherein said beam is hollow and wherein said end plate attachment to said beam is accomplished using a protrusion on said end plate and wherein said protrusion has approximately the same dimensions as the inner dimensions of said beam relative to width and height.

14. The apparatus of claim 1, wherein each said end plate is designed to rotate, at least partially, around an axis at the point of attachment to said article conveyance device.

15. The apparatus of claim 1, wherein said ends of each of said arms opposite said beam face inwardly relative to said personal mobility device.

16. The apparatus of claim 1, further comprising an article conveyance device attached to said end plates.

17. The apparatus of claim 1, further comprising a personal mobility device attached to said ends of said attachable arms.

18. An article conveyance device attachment apparatus, comprising:
a pair of attachable arms;
wherein an end of each of said arms is designed to receive and retain a portion of a personal conveyance device; and
wherein an end of each of said arms is designed to attach to an article conveyance device.

19. The apparatus of claim 18, wherein at least one of said arms is attached to the footrest frame of a personal mobility device.

20. The apparatus of claim 18, wherein said ends for receiving and retaining are cup shaped.

21. The apparatus of claim 18, wherein said end for receiving and retaining and its corresponding arm are of a unitary construction.

22. The apparatus of claim 18, wherein said end for receiving and retaining and its corresponding arm are connected.

23. The apparatus of claim 18, wherein said end for receiving and retaining and its corresponding arm are rotatably connected.

24. The apparatus of claim 1, wherein said end for receiving and retaining is a clip.

25. The apparatus of claim 18, wherein each of said arms is designed to flex in order to accommodate personal mobility devices of varying designs.

26. The apparatus of claim 18, wherein each of said arms is designed to flex in order to accommodate personal mobility devices of varying designs and said flex is accomplished using a hinge.

27. The apparatus of claim 18, wherein each of said arms is designed to flex in order to accommodate personal mobility devices of varying designs and said flex is accomplished using a spring-loaded hinge.

28. The apparatus of claim 18, wherein said end for attaching is designed to connect to an article conveyance device and rotate, at least partially, around an axis.

29. The apparatus of claim 18, wherein said ends for receiving and retaining face inwardly relative to a personal mobility device.

30. The apparatus of claim 18, further comprising an article conveyance device attached to said end plates.

31. The apparatus of claim 18, further comprising a personal mobility device attached to said ends for receiving and retaining.

32. An article conveyance device attachment apparatus, comprising:
a beam;
a pair of arms, mounted at a central point along said beam; and
a pair of end plates attached to said beam;
wherein the end of each of said arms opposite the beam is designed to receive a portion of a personal conveyance device; and
wherein said end plates are designed to attach to an article conveyance device.

33. The apparatus of claim 32, wherein said beam is square, relative to width and height.

34. The apparatus of claim 32, wherein the length of said beam is approximately the width of said article conveyance device.

35. The apparatus of claim 32, wherein said arms are designed to attach to the footrest frame portion of said personal mobility device.

36. The apparatus of claim 32, wherein said end of each of said arms opposite said beam is cup shaped.

37. The apparatus of claim 32, wherein said end of each of said arms opposite said beam is connected to said arm.

38. The apparatus of claim 32, wherein said end of each of said arms opposite said beam is rotatably connected to said arm.

39. The apparatus of claim 32, wherein said end of each of said arms opposite said beam is a clip designed to retain a portion of a personal mobility device.

40. The apparatus of claim 32, wherein each said end plate is permanently attached to an end of said beam.

41. The apparatus of claim 32, wherein said beam is hollow and wherein said end plate attachment to said beam is accomplished using a protrusion on said end plate.

42. The apparatus of claim 32, wherein said beam is hollow and wherein said end plate attachment to said beam is accomplished using a protrusion on said end plate and wherein said protrusion has approximately the same dimensions as the inner dimensions of said beam relative to width and height.

43. The apparatus of claim 32, wherein each said end plate is designed to rotate, at least partially, around an axis at the point of attachment to said article conveyance device.

44. The apparatus of claim 32, wherein said ends of each of said arms opposite said beam face inwardly relative to said personal mobility device.

45. The apparatus of claim 32, further comprising an article conveyance device attached to said end plates.

46. The apparatus of claim 32, further comprising a personal mobility device attached to said ends of said attachable arms.

47. The apparatus of claim 32, wherein said arms are pivotably mounted at said central point.

48. The apparatus of claim 32, wherein said arms are mounted at said central point using a hinge.

49. The apparatus of claim 32, wherein said arms are mounted at said central point using a pin.

50. The apparatus of claim 32, wherein said arms are mounted at said central point such that the arms can move horizontally to accommodate varying widths of personal mobility devices.

51. The apparatus of claim 32, wherein said arms are mounted at said central point using a tension-type device.
